(19) United States
(12) Patent Application Publication
(10) Pub. No.: US 2015/0235326 A1
(43) Pub. Date: Aug. 20, 2015

(54) METHOD AND APPARATUS FOR ACTIVATED CARBON MASTER LIMITED PARTNERSHIP OPERATION

(71) Applicant: ADA Carbon Solutions, LLC, Littleton, CO (US)

(72) Inventors: Ronald Peter Owen Hansen, Brighton, CO (US); Richard S. Lee, Superior, CO (US)

(21) Appl. No.: 14/627,724

(22) Filed: Feb. 20, 2015

Related U.S. Application Data
(60) Provisional application No. 61/942,572, filed on Feb. 20, 2014.

(51) Int. Cl. G06Q 40/00

(52) U.S. Cl. CPC G06Q 40/12

(57) ABSTRACT

Operation of a business that is involved in the preparation or supply of pollutant capture sorbent products within a master limited partnership (MLP) structure is facilitated by the methods, systems and computer program products described herein. In one embodiment, a method for operating a business involving carbon-based mercury capture sorbent product may include performing at least one processing or supply activity in connection with preparing or supplying mercury capture sorbent product comprising sorbent particles with a porous carbonaceous structure comprising carbon from coal, receiving revenue as a consequence of performing the at least one activity, and distributing at least a portion of the revenue to at least one MLP unit holder pursuant to provisions of a MLP agreement.

### RELATED APPLICATION INFORMATION

This application claims priority from U.S. Provisional Application Ser. No. 61/942,572, entitled “METHOD AND APPARATUS FOR ACTIVATED CARBON MASTER LIMITED PARTNERSHIP OPERATION”, and filed Feb. 20, 2014. The entirety of this application is incorporated herein by reference.

### FIELD OF THE INVENTION

The present invention relates generally to the operation of a business involving pollutant capture sorbent products, and more particularly to operating such a business within a master limited partnership structure.

### BACKGROUND OF THE INVENTION

Many electrical generating power plants utilize coal as fuel. The burning of coal in such power plants may release various pollutants, such as, for example, mercury. One manner of reducing the amount of such pollutants released into the atmosphere is to utilize a pollutant capture sorbent product at the power plant such as, for example, a mercury capture sorbent product useful in capturing mercury and possibly also other pollutants. In order to supply power plant operators and other potential users or distributors of mercury capture sorbent products, a business may be conducted which engages in various processing and supply activities relating to the preparation or supply of mercury capture sorbent products.

One manner in which a business may be organized is referred to as a master limited partnership (MLP). A MLP is a business structure governed by a contract between management and investors. The management of a MLP may be identified as the general partner in the MLP and the investors may be identified as the limited partners in the MLP, and limited partner investment units in the MLP may be publicly traded. Structuring a business as a MLP may be advantageous because a MLP combines benefits of pass-through financials of a limited partnership with the liquidity of publicly traded securities. In this regard, qualifying, publicly traded MLPs may pass through financial items such as all income, gains, losses and deductions of a MLP to the partners of the MLP (MLP unit holders). Taxation consequences of such pass-through financial items are for the unit holder rather than the MLP. A result of operating as a MLP may be enhanced valuation relative to other forms of business operation.

### SUMMARY OF THE INVENTION

Accordingly, the present inventors have recognized that it may be advantageous to operate a business that is involved in processing or supply activities in relation to pollutant capture sorbent products within a MLP structure.

In one aspect, a method for operating a business involving carbon-based mercury capture sorbent product may include performing at least one processing or supply activity in connection with preparing or supplying mercury capture sorbent product comprising sorbent particles with a porous carbonaceous structure comprising carbon from coal. The method may also include receiving revenue as a consequence of performing the at least one activity. The method may further include distributing at least a portion of the revenue to at least one MLP unit holder pursuant to provisions of a MLP agreement.

The method may include one or more of the following aspects and examples:
(1) the porous carbonaceous structure comprises activated carbon made by processing including devolatilization and activation of coal feed;
(2) the coal feed comprises lignite coal feed;
(3) the sorbent particles comprise a mercury oxidation enhancement additive supported on the porous carbonaceous structure;
(4) the mercury oxidation enhancement additive comprises a halogen;
(5) the halogen comprises bromine;
(6) the halogen is in a halide form;
(7) the sorbent product comprises from 20 weight percent to 75 weight percent fixed carbon of the porous carbonaceous structure and from 20 weight percent to 50 weight percent non-carbon minerals;
(8) the porous carbonaceous structure is a product of processing comprising devolatilization and activation of coal feed, and the minerals are ash-forming minerals native to the coal feed;
(9) the at least one activity comprises bulk sale of the sorbent product;
(10) the at least one activity comprises making the porous carbonaceous structure from processing coal feed, the processing comprising devolatilization and activation of the coal feed;
(11) the at least one activity comprises adding an additive to a composition comprising porous particles including the porous carbonaceous structure;
(12) the additive comprises a mercury oxidation enhancement additive;
(13) the at least one activity comprises supporting a chemical additive on the porous carbonaceous structure;
(14) the at least one activity comprises mixing a particulate additive with porous particles including the porous carbonaceous structure;
(15) the at least one activity comprises transportation of the sorbent product;

(16) the at least one activity comprises transloading the sorbent product;
(17) the at least one activity comprises storing the sorbent product;
(18) the method further comprises performing at least one ancillary service that is not a processing or supply activity in connection with preparing or supplying the mercury capture sorbent product;
   receiving ancillary service revenue as a consequence of performing the at least one ancillary service; and
   not distributing any portion of the ancillary service revenue to a unit holder of the master limited partnership pursuant the master limited partnership agreement;
(19) the at least one processing or supply activity is performed by a first business entity and the ancillary service is performed by a second business entity;
(20) the at least one ancillary service comprises an activity selected from the group consisting of testing performance of mercury capture efficacy of a mercury capture sorbent product and providing consultation in relation to use of a mercury capture sorbent product;
(21) the distributing comprises:
   storing financial data of the business on at least one data storage device, the financial data characterizing amounts of revenue received as a consequence of performing the at least one activity and dates of receipt of the amounts of revenue; and
   processing the financial data with at least one processor enabled to retrieve the financial data from the at least one data storage device and to calculate the at least a portion of the revenue to be distributed to at least one master limited partnership unit holder pursuant to provisions of the master limited partnership agreement; and/or
(22) the at least one processor calculates the at least a portion of revenue to be distributed by applying provisions of the master limited partnership agreement implemented as a set of logical rules expressed in computer readable program code executable by the at least one processor.

In another aspect, a system facilitating operation of a business involving carbon-based mercury capture sorbent product may include a processor and a memory logically connected to the processor and comprising a set of computer readable instructions. The computer readable instructions are executable by the processor to: (1) track the receipt of revenue received by the business as a consequence of performing at least one activity, the at least one activity comprising a processing or supply activity performed in connection with preparing or supplying mercury capture sorbent product comprising sorbent particles with a porous carbonaceous structure comprising carbon from coal; and (2) calculate at least a portion of the revenue to be distributed to at least one MLP unit holder pursuant to provisions of a MLP agreement.

The system may include one or more of the following aspects and examples:
(1) the porous carbonaceous structure comprises activated carbon made by processing including devolatilization and activation of coal feed;
(2) the coal feed comprises lignite coal feed;
(3) the sorbent particles comprise a mercury oxidation enhancement additive supported on the porous carbonaceous structure;
(4) the mercury oxidation enhancement additive comprises a halogen;
(5) the halogen comprises bromine;
(6) the halogen is in a halide form;
(7) the sorbent product comprises from 20 weight percent to 75 weight percent fixed carbon of the porous carbonaceous structure and from 20 weight percent to 50 weight percent non-carbon minerals;
(8) the porous carbonaceous structure is a product of processing comprising devolatilization and activation of coal feed, and the minerals are ash-forming minerals native to the coal feed;
(9) the at least one activity comprises bulk sale of the sorbent product;
(10) the at least one activity comprises making the porous carbonaceous structure from processing coal feed, the processing comprising devolatilization and activation of the coal feed;
(11) the at least one activity comprises adding an additive to a composition comprising porous particles including the porous carbonaceous structure;
(12) the additive comprises a mercury oxidation enhancement additive;
(13) the at least one activity comprises supporting a chemical additive on the porous carbonaceous structure;
(14) the at least one activity comprises mixing a particulate additive with porous particles including the porous carbonaceous structure;
(15) the at least one activity comprises transportation of the sorbent product;
(16) the at least one activity comprises transloading the sorbent product;
(17) the at least one activity comprises storing the sorbent product;
(18) the computer readable instructions are further executable by the processor to:
   track receipt of revenue received by the business as a consequence of performing at least one ancillary service, the at least one ancillary service being an activity other than a processing or supply activity performed in connection with preparing or supplying the mercury capture sorbent product; and
   avoid distributing any portion of the ancillary service revenue to a unit holder of the master limited partnership;
(19) the at least one processing or supply activity is performed by a first business entity and the ancillary service is performed by a second business entity;
(20) the at least one ancillary service comprises an activity selected from the group consisting of testing performance of mercury capture efficacy of a mercury capture sorbent product and providing consultation in relation to use of a mercury capture sorbent product;
(21) the system further comprises:
   at least one data storage device storing financial data characterizing amounts of revenue received as a consequence of performing the at least one activity and dates of receipt of the amounts of revenue, the processor being enabled to retrieve the financial data from the at least one data storage device; and/or
(22) the provisions of the master limited partnership agreement are implemented as a set of logical rules expressed in computer readable program code executable by the processor.

In a further aspect, a computer program product usable by a business involving carbon-based mercury capture sorbent product may include a non-transitory computer useable medium having computer program code embodied therein. The computer program code embodied on the non-transitory computer useable medium may include computer readable program code enabling a processor to track the receipt of revenue received by the business as a consequence of performing at least one activity, the at least one activity comprising a processing or supply activity performed in connection with preparing or supplying mercury capture sorbent product comprising sorbent particles with a porous carbonaceous structure comprising carbon from coal.

The computer program code embodied on the non-transitory computer useable medium may also include computer readable program code enabling a processor to calculate at least a portion of the revenue to be distributed to at least one MLP unit holder pursuant to provisions of a MLP agreement.

The computer program product may include one or more of the following aspects and examples:
(1) the porous carbonaceous structure comprises activated carbon made by processing including devolatilization and activation of coal feed;
(2) the coal feed comprises lignite coal feed;
(3) the sorbent particles comprise a mercury oxidation enhancement additive supported on the porous carbonaceous structure;
(4) the mercury oxidation enhancement additive comprises a halogen;
(5) the halogen comprises bromine;
(6) the halogen is in a halide form;
(7) the sorbent product comprises from 20 weight percent to 75 weight percent fixed carbon of the porous carbonaceous structure and from 20 weight percent to 50 weight percent non-carbon minerals;
(8) the porous carbonaceous structure is a product of processing comprising devolatilization and activation of coal feed, and the minerals are ash-forming minerals native to the coal feed;
(9) the at least one activity comprises bulk sale of the sorbent product;
(10) the at least one activity comprises making the porous carbonaceous structure from processing coal feed, the processing comprising devolatilization and activation of the coal feed;
(11) the at least one activity comprises adding an additive to a composition comprising porous particles including the porous carbonaceous structure;
(12) the additive comprises a mercury oxidation enhancement additive;
(13) the at least one activity comprises supporting a chemical additive on the porous carbonaceous structure;
(14) the at least one activity comprises mixing a particulate additive with porous particles including the porous carbonaceous structure;
(15) the at least one activity comprises transportation of the sorbent product;
(16) the at least one activity comprises transloading the sorbent product;
(17) the at least one activity comprises storing the sorbent product;
(18) the computer program code further includes:
   computer readable program code enabling a processor to track receipt of revenue received by the business as a consequence of performing at least one ancillary service, the at least one ancillary service being an activity other than a processing or supply activity performed in connection with preparing or supplying the mercury capture sorbent product; and
   computer readable program code enabling a processor to avoid distributing any portion of the ancillary service revenue to a unit holder of the master limited partnership;
(19) the at least one processing or supply activity is performed by a first business entity and the ancillary service is performed by a second business entity;
(20) the at least one ancillary service comprises an activity selected from the group consisting of testing performance of mercury capture efficacy of a mercury capture sorbent product and providing consultation in relation to use of a mercury capture sorbent product;
(21) the provisions of the master limited partnership agreement are implemented as a set of logical rules expressed in computer readable program code enabling a processor to distribute at least a portion of the revenue to at least one master limited partnership unit holder; and/or
(22) the computer program product further comprises:
   computer readable program code enabling a processor to retrieve financial data stored on at least one data storage device, the financial data characterizing amounts of revenue received as a consequence of performing the at least one activity and dates of receipt of the amounts of revenue.

Various refinements exist of the features noted in relation to the various aspects of the present invention. Further features may also be incorporated in the various aspects of the present invention. These refinements and additional features may exist individually or in any combination, and various features of the various aspects may be combined. These and other aspects and advantages of the present invention will be apparent upon review of the following Detailed Description and the claims when taken in conjunction with the accompanying figures.

### DESCRIPTION OF THE DRAWINGS

For a more complete understanding of the present invention and further advantages thereof, reference is now made to the following Detailed Description, taken in conjunction with the drawings, in which:

FIG. 1 illustrates one embodiment of an activated carbon business operated as a MLP;

FIG. 2 is a block diagram illustrating one embodiment of a system that may be used to facilitate operation of a business involving activated carbon as a MLP; and

FIG. 3 illustrates the steps included in one embodiment of a method for operating a business involving activated carbon as a MLP.

### DETAILED DESCRIPTION

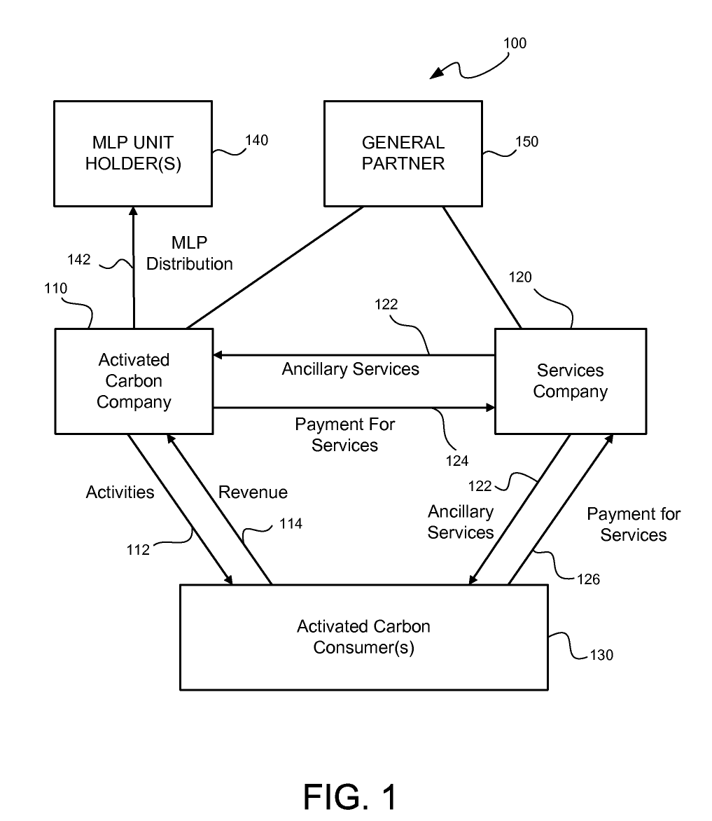

FIG. 1 illustrates one embodiment of a business structure 100 directed to the preparation and/or supply of a pollutant capture sorbent product where the business is organized as a MLP. In this regard, the pollutant capture sorbet product may, for example, comprise a mercury capture sorbent product. The mercury capture sorbent product may, for example, comprise sorbent particles with a porous carbonaceous structure comprising carbon from, for example, coal. In this regard, the mercury capture sorbent product may comprise activated carbon, and the activated carbon may include one or more additives that enhance its effectiveness as a mercury capture sorbent product.

The business structure 100 may include a first business entity comprising an activated carbon company 110 and a second business entity comprising a services company 120. The activated carbon company 110 and the services company 120 are separate legal entities. The services company may be owned or controlled by a general partner 150 of the MLP or an affiliate of the general partner 150. The activated carbon company 110 conducts various activities 112 (e.g., processing, supplying, transportation, transloading, and/or storing) in connection with preparing or supplying activated carbon products. The activated carbon products may be provided to one or more activated carbon consumers 130. The activated carbon consumers 130 may, for example, comprise power plant operators who utilize the activated carbon to capture pollutants such as mercury. The activated carbon company 110 may receive revenue 114 from the activated carbon consumer(s) 130 in exchange for providing the activated carbon.

The services company 120 may provide services 122 that are ancillary to the processing or supply activities conducted by the activated carbon company 110. In this regard, the ancillary services 122 may be types of activities that cannot be conducted by a MLP in order for the MLP to maintain its tax-advantaged status. In this regard, the services company 120 may provide ancillary services 122 to the activated carbon company 110 and/or to the activated carbon consumer(s) 130 such as, for example, testing the performance of mercury capture efficacy of a mercury capture sorbent product and consulting in relation to the utilization of a mercury capture sorbent product. In exchange for providing the ancillary services 122, the services company 120 may receive payments 124 from the activated carbon company 110 and/or payments 126 from the activated carbon consumers 130.

The revenue 114 that is received by the activated carbon company 110 as a result of conducting the processing and/or supply activity (less costs of conducting such activities and payments 124 to the services company 120, if any) may be distributed by the activated carbon company 110. In this regard, the revenue 114 may be distributed to one or more MLP unit holders 140 in the form of a distribution 142 (e.g. a cash payment) in accordance with the provisions of a MLP agreement among the general and limited partners. By way of example, where there are five MLP unit holders 140 and the MLP contract specifies equal shares of the applicable distribution 142 among such MLP unit holders 140, each MLP unit holder 140 may receive a one-fifth share of the applicable distribution 142. In other examples, the MLP unit holders 140 may receive unequal shares of the distribution 142 and the shares received by the MLP unit holders 140 may, on average, represent smaller or larger portions of the overall distribution 142 depending on the number of MLP unit holders 140.

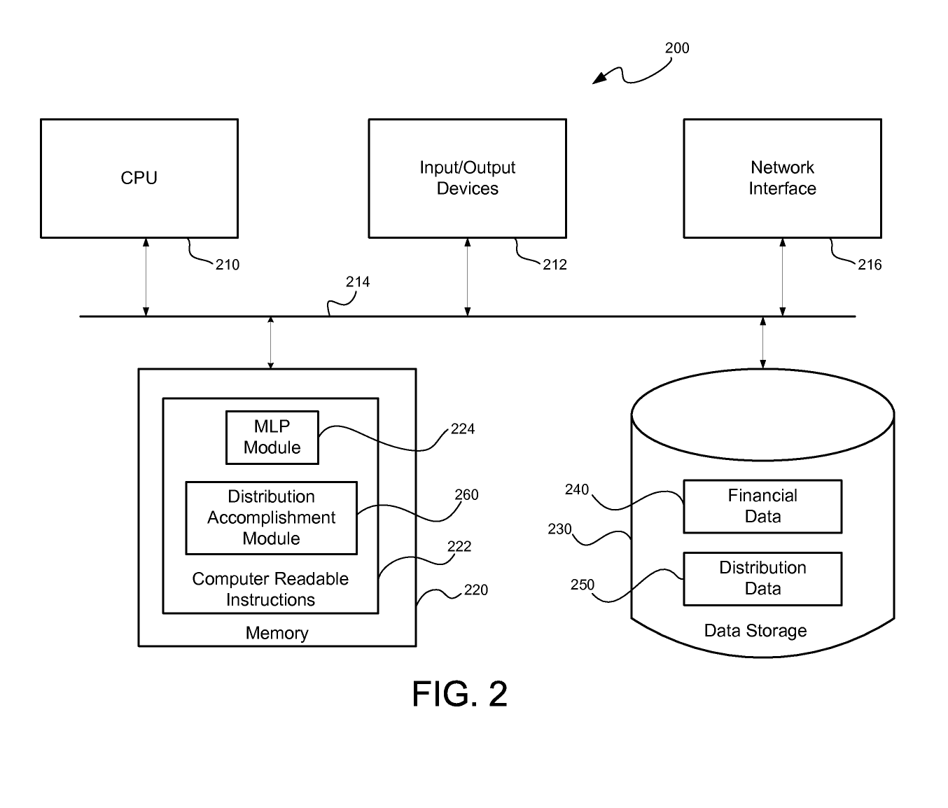

FIG. 2 shows one embodiment of a system 200 that may be used to facilitate operation of a business involving carbon-based mercury capture sorbent product as a MLP. The system 200 may include a central processing unit 210 (also referred to herein as processor 210) logically connected to one or more input/output devices 212 via a system bus 214. The input/output devices 212 may include, for example, a keyboard, mouse, touch screen, display, printer and the like. The system 200 may also include a network interface 216 logically connected to the system bus 214 that permits the system 200 to communicate with other network connected devices via a data communications network (not shown).

The system 200 may also include a memory 220 logically connected to the processor 210 via the system bus 214. The memory 220 may include a set of computer readable instructions 222 that are executable by the processor 210. In this regard, the computer readable instructions 222 may be loaded into the memory 220 prior to and/or during execution thereof by the processor 210 from one or more data storage devices 230. As illustrated, the data storage device(s) 230 may be logically connected to the memory 220 directly via the system bus 214. In other embodiments, one or more of the data storage devices 230 may be logically connected to the memory 220 indirectly via the system bus 214, the network interface 216, and a network. The data storage device(s) 230 may comprise a non-transitory computer usable medium having computer program code embodied therein. Examples of such computer usable mediums may include, without limitation, hard disk drives, optical disks readable by optical drives, flash drives, floppy disks readable by floppy drives, and remote server computers.

The computer readable instructions 222 on the memory 220 may include a MLP module 224 comprising executable program code implementing a set of logical rules defining the terms and conditions of an activated carbon MLP. The activated carbon MLP module 224 reflects the relationships between the activated carbon business managers (e.g., the general partner 150) and the activated carbon business investors (e.g., the limited partners or MLP unit holders 140) in accordance with the MLP agreement among them. The MLP module 224 may specify operating parameters, such as ownership interests, capital structures, investment policies, cash distribution levels, and management rights, and such operating parameters are implemented in the logic of the computer readable instructions 222. In the regard, the MLP module 224 may operate to separate revenues received as a result of the activities 112 conducted by the activated carbon company 110 from the ancillary services 122 conducted by the services company 120. By way of example, the computer readable instructions 222 of the MLP module 224 may include a set of conditional (e.g., if-then-else) statements that control rights and resources in accordance with an underlying activated carbon MLP. In this regard, various programming techniques can be utilized by a software engineer to prepare the set of logical rules in appropriate executable program code based upon the terms of the activated carbon MLP.

During execution by the processor 210, the MLP module 224 may cause the processor 210 to retrieve various financial data 240. The financial data 240 may, as illustrated, be stored on the one or more data storage devices 230 logically connected to the processor 210 via the system bus 214. Some or all of the financial data 240 may also be stored on a data storage device outside of the system 200 and accessible to the processor 210 via the system bus 214, the network interface 216 and a network. Some or all of the financial data 240 may also be input by a user of the system 200 via one or more of the input devices 212 during execution of the computer readable instructions 222 by the processor 210. The financial data 240 may characterize amounts of revenue 114 received by the activated carbon company 110 as a consequence of performing the activities 112. The financial data 240 may also characterize costs incurred by the activated carbon company 110 in conducting the activities 112. As executed by the processor 210, the MLP module 224 applies the set of logical rules to the financial data 240 to calculate distribution data 250. The distribution data 250 specifies the respective portions of MLP income that are distributed to the MLP unit holders 140.

The distribution data 250 may be written by the processor 210 to the memory 220 and/or to the data storage device(s) 230. The distribution data 250 may be output via one of the input/output devices 212 (e.g. via a printer or a display) to a user of the system 200. Thereafter, the user may themselves or by directing others to do so, manually prepare the appropriate distributions to the MLP unit holders 140 The computer readable instructions 222 may also include a distribution accomplishment module 260 that automatically accomplishes distribution of the funds to the MLP unit holders 140 by, for example, printing appropriate checks, making direct deposits into bank accounts of the MLP unit holders 140, or arranging for wire transfers into the bank accounts of the MLP unit holders 140. Such automatic distributions may, for example, be released only after approval by a user of the system 200 who reviews the displayed distribution data 250 such as the respective MLP unit holder 140 portions the MLP income.

As mentioned, in one embodiment the computer readable instructions 222 may be embodied on a non-transitory computer usable medium, and as such may be considered to comprise a computer program product usable by a business involving carbon-based mercury capture sorbent product. The medium and the computer program code embodied thereon may be of a type specifically designed and constructed for the purposes of accomplishing the requirements of the MLP agreement, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in special purpose logic circuitry, e.g., an FPGA (field programmable gate array) or an ASIC (application-specific integrated circuit) in place of, or in combination with, machine-executable software instructions.

As also discussed previously, the various modules and the like disclosed herein may be in the form of any appropriate combination of hardware, software, middleware, firmware and/or the like operable to carry out the various functionalities disclosed herein. For instance, such software, middleware and/or firmware may be implemented as one or more computer program products, i.e., one or more modules of computer program instructions encoded on a computer-readable medium for execution by one or more processors or processing modules, or to control the operation of, one or more data processing apparatuses. For example, the engines and tools in the MLP module 224 and/or the distribution accomplishment module 260 may be provided in such computer-readable medium and executed by a processor or the like. The computer-readable medium can be a machine-readable storage device, a machine-readable storage substrate, a memory device, a composition of matter affecting a machine-readable propagated signal, or a combination of one or more of them. In addition to hardware, the system 200 may include code that creates an execution environment for the computer program in question, e.g., code that constitutes processor firmware, a protocol stack, a database management system, an operating system, or a combination of one or more of them.

A computer program (also known as a program, software, software application, script, or code) used to provide the functionality described herein (such as to provide the various MLP income distribution functionalities disclosed herein) may be written in any form of programming language, including compiled or interpreted languages, and may be deployed in any form, including as a stand-alone program or as a module, component, subroutine, or other unit suitable for use in a computing environment. The engines and tools in the MLP module 224 and/or the distribution accomplishment module 260 may, for example, also be implemented within a spreadsheet and/or database program environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by an information flow network.

The block diagrams, processes, protocols and logic flows described in this specification can be performed by one or more programmable processors executing one or more computer programs to perform functions by operating on input data and generating output. The processes and logic flows may also be performed by, and apparatuses may also be implemented as, special purpose logic circuitry, e.g., an FPGA and/or an ASIC. Processors suitable for the execution of a computer program include, by way of example, both general and special purpose microprocessors, and any one or more processors of any kind of digital computer. Generally, a processor will receive instructions and data from a read-only memory or a random access memory or both. Generally, the elements of a computer are a processor for performing instructions and one or more memory devices for storing instructions and data. The techniques described herein may be implemented by a computer system configured to provide the functionality described.

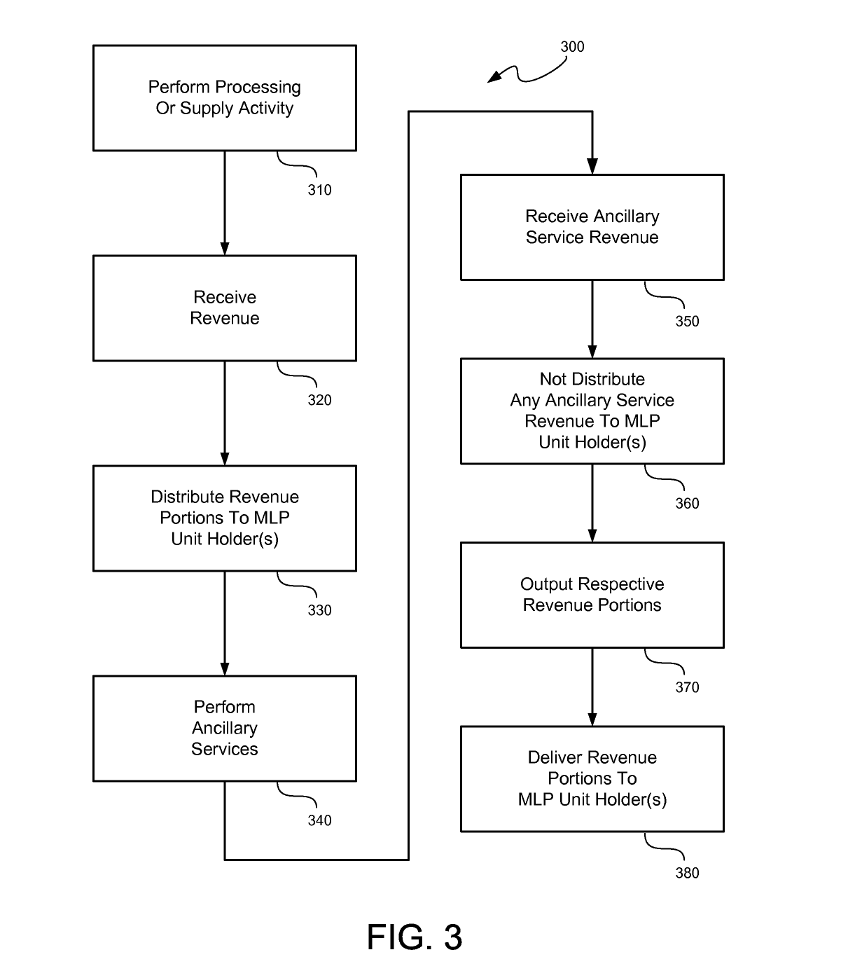

FIG. 3 illustrates the steps that may be included in a method 300 for operating a business involving carbon-based mercury capture sorbent product, such as for example activated carbon, as a MLP. In step 310, at least one processing or supply activity is performed in connection with preparing or supplying mercury capture sorbent product comprising sorbent particles with a porous carbonaceous structure comprising carbon from coal. In this regard, step 310 may be undertaken by an activated carbon company 110 such as illustrated in FIG. 1. In step 320, revenue is received (e.g., as a result of sale or leasing) by the activated carbon company as a consequence of performing the at least one activity. In this regard, the revenue may be received from activated carbon consumer(s) 130 such as illustrated in FIG. 1. In step 330, respective portions of the revenue are distributed to one or more MLP unit holders pursuant to provisions of a MLP agreement, such as, for example to MLP unit holder(s) 140 illustrated in FIG. 1.

The step 310 of performing at least one processing or supply activity may include various sub-steps including, for example: (1) undertaking processing including devolatilization and activation of coal feed to achieve a porous carbonaceous structure comprising activated carbon; and/or (2) supporting a mercury oxidation enhancement additive on the porous carbonaceous structure. Some additional examples of processing activities are provided in the claims below.

The step 310 of performing at least one processing or supply activity may, for example, comprise: (1) conducting the bulk sale of the sorbent product; (2) conducting transportation of the sorbent product; (3) conducting transloading of the sorbent product; and/or (4) storing the sorbent product.

The method 300 may also include the step of 340 of performing at least one ancillary service that is not a processing or supply activity in connection with preparing or supplying the mercury capture sorbent product, the step of 350 of receiving ancillary service revenue as a consequence of performing the at least one ancillary service, and step 360 wherein any portion of the ancillary service revenue is not distributed to a MLP unit holder. In this regard, the ancillary service may performed by services company 120 such as illustrated in FIG. 1.

The step 330 of distributing at least a portion of the revenue may include various sub-steps including, for example: (1) storing financial data of the business on at least one data storage device where the financial data characterizes amounts of revenue received as a consequence of performing the at least one activity and also possibly dates of receipt of the amounts of revenue; and (2) processing the financial data with at least one processor enabled to retrieve the financial data from the at least one data storage device and to calculate the at least a portion of the revenue to be distributed to the MLP unit holder.

One or more of the steps of the method 300 may undertaken with the assistance of a system 200 such as described in connection with FIG. 2. For example, a processor 210 of system 200 may used to calculate the respective portion of revenues to be distributed to the MLP unit holder(s) by applying provisions of the MLP agreement implemented as a set of logical rules expressed in computer readable program code executable by the processor 210.

The method 300 may also include step 370 of outputting (e.g. on a display device or a printer) the respective calculated portions of revenue to be distributed to the MLP unit holders. The method 300 may also include step 380 of delivering the calculated respective revenue portions to the MLP unit holder(s). In this regard, steps 370 and 380 may also be undertaken with the assistance of a system 200 such as described in connection with FIG. 2.

While this disclosure contains many specifics, these should not be construed as limitations on the scope of the disclosure or of what may be claimed, but rather as descriptions of features specific to particular embodiments of the disclosure. Certain features that are described in this specification in the context of separate embodiments and/or arrangements can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Additionally, the foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed is:

1. A method for operating a business involving carbon-based mercury capture sorbent product, the method comprising:
performing at least one processing or supply activity in connection with preparing or supplying mercury capture sorbent product comprising sorbent particles with a porous carbonaceous structure comprising carbon from coal;
receiving revenue as a consequence of performing the at least one activity; and
distributing at least a portion of the revenue to at least one master limited partnership unit holder pursuant to provisions of a master limited partnership agreement.

2. A method according to claim 1, wherein the porous carbonaceous structure comprises activated carbon made by processing including devolatilization and activation of coal feed.

3. A method according to claim 1, wherein the sorbent particles comprise a mercury oxidation enhancement additive supported on the porous carbonaceous structure.

4. A method according to claim 1, wherein the sorbent product comprises from 20 weight percent to 75 weight percent fixed carbon of the porous carbonaceous structure and from 20 weight percent to 50 weight percent non-carbon minerals.

5. A method according to claim 1, wherein the at least one activity comprises bulk sale of the sorbent product.

6. A method according to claim 1, wherein the at least one activity comprises making the porous carbonaceous structure from processing coal feed, the processing comprising devolatilization and activation of the coal feed.

7. A method according to claim 1, wherein the at least one activity comprises adding an additive to a composition comprising porous particles including the porous carbonaceous structure.

8. A method according to claim 1, wherein the additive comprises a mercury oxidation enhancement additive.

9. A method according to claim 1, wherein the at least one activity comprises supporting a chemical additive on the porous carbonaceous structure.

10. A method according to claim 1, wherein the at least one activity comprises mixing a particulate additive with porous particles including the porous carbonaceous structure.

11. A method according to claim 1, wherein the at least one activity comprises transportation of the sorbent product.

12. A method according to claim 1, wherein the at least one activity comprises transloading the sorbent product.

13. A method according to claim 1, wherein the at least one activity comprises storing the sorbent product.

14. A method according to claim 1, further comprising:
performing at least one ancillary service that is not a processing or supply activity in connection with preparing or supplying the mercury capture sorbent product;
receiving ancillary service revenue as a consequence of performing the at least one ancillary service; and
not distributing any portion of the ancillary service revenue to a unit holder of the master limited partnership pursuant the master limited partnership agreement.

15. A method according to claim 14, wherein the at least one processing or supply activity is performed by a first business entity and the ancillary service is performed by a second business entity.

16. A method according to claim 14, wherein the at least one ancillary service comprises an activity selected from the group consisting of testing performance of mercury capture efficacy of a mercury capture sorbent product and providing consultation in relation to use of a mercury capture sorbent product.

17. A method according to claim 1, wherein said distributing comprises:
storing financial data of the business on at least one data storage device, the financial data characterizing amounts of revenue received as a consequence of performing the at least one activity and dates of receipt of the amounts of revenue; and
processing the financial data with at least one processor enabled to retrieve the financial data from the at least one data storage device and to calculate the at least a portion of the revenue to be distributed to at least one master limited partnership unit holder pursuant to provisions of the master limited partnership agreement.

18. The method according to claim 17 wherein the at least one processor calculates the at least a portion of revenue to be distributed by applying provisions of the master limited partnership agreement implemented as a set of logical rules expressed in computer readable program code executable by the at least one processor.

19. A system facilitating operation of a business involving carbon-based mercury capture sorbent product, the system comprising:
a processor; and
a memory logically connected to the processor and comprising a set of computer readable instructions executable by the processor to:
track the receipt of revenue received by the business as a consequence of performing at least one activity, the at least one activity comprising a processing or supply activity performed in connection with preparing or supplying mercury capture sorbent product comprising sorbent particles with a porous carbonaceous structure comprising carbon from coal; and
calculate at least a portion of the revenue to be distributed to at least one master limited partnership unit holder pursuant to provisions of a master limited partnership agreement.

20. A computer program product usable by a business involving carbon-based mercury capture sorbent product, the computer program product comprising:
a non-transitory computer useable medium having computer program code embodied therein, the computer program code including:
computer readable program code enabling a processor to track the receipt of revenue received by the business as a consequence of performing at least one activity, the at least one activity comprising a processing or supply activity performed in connection with preparing or supplying mercury capture sorbent product comprising sorbent particles with a porous carbonaceous structure comprising carbon from coal; and
computer readable program code enabling a processor to calculate at least a portion of the revenue to be distributed to at least one master limited partnership unit holder pursuant to provisions of a master limited partnership agreement.
